(19) United States
(12) Patent Application Publication
(10) Pub. No.: US 2003/0018528 A1
(43) Pub. Date: Jan. 23, 2003

(54) Selling system for selling products by using a network and a method for same

(76) Inventors: Masaru Sakatsume, Ebina (JP); Masayuki Kan, Yokohama (JP); Kyoji Chiba, Hadano (JP); Takahiro Tsukishima, Zushi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/160,087

(22) Filed: Jun. 4, 2002

(30) Foreign Application Priority Data
Jun. 4, 2001 (JP) 2001-167605

(51) Int. Cl. G06F 17/60

(52) U.S. Cl. 705/14

(57) ABSTRACT

A Web selling system in which when the number of products which can be supplied is lacking for the number of orders, postponement of delivery dates of products is advertised to the customers and, when the customers voluntarily apply for the advertisement, the products are sold and provided to them together with an additional value like a price discount.

### BACKGROUND OF THE INVENTION

The invention relates to a network selling system for accepting orders from customers by a network, presenting prices of products and delivery dates thereof, and selling the products and to a method for such a system.

Not only in commerce on the Internet, in conventional sales of products, early delivery after the order acceptance is realized by well-planned production using demand prediction and advancement of a (contracted) delivery date of parts. However, there is a case where the number of suppliable products (that is, the number of products which can be supplied) runs short for the demand due to factors such as

sudden change in parts supply system

(accident in a business connection/increase in defective products)

wrong demand prediction

(rush of orders exceeding the prediction from the customers)

limitation in a production capacity

and the like

In such a case, the selling side sells the products to the customers who ordered later by delaying delivery dates or one-sidedly requests the customers manually extracted on the basis of order acceptance conditions such as selling price and payment method to accept postponement of the contracted delivery dates by using a telephone, a facsimile apparatus, or the like.

As another method, as disclosed in JP-A-2000-57214, in order to preliminarily reduce a risk of shortage of supply in production by estimate, in the case where the delivery date which the customer desires is late, a product price is set in association with the delivery date.

According to the conventional technique, when the selling side enters the orders, since prediction of a future supply-demand balance is difficult, the orders are entered in order from the earliest order application irrespective of prices or payment conditions. There is, consequently, a case where even if an order of good payment conditions and an early delivery date is placed later, since all materials have already been allowed, the order acceptance has to be abandoned.

As another case, in the case where the number of suppliable products runs short for the demand, the customer side is one-sidedly notified of the delayed delivery date by the selling side or merely requested by the selling side to accept postponement of the delivery date, so that there is no advantage to the customer. There is also a case where when the selling side presents conditions of the delayed delivery date, the customer abandons the order and purchases his desired product from another company, or the like, so that the selling side misses a chance for the order acceptance.

According to the technique disclosed in JP-A-2000-57214, it is an object to reduce a risk on the selling side, and nothing is considered with respect to a correspondence in the case where the supply of products actually runs short for the demand.

### SUMMARY OF THE INVENTION

It is an object of the invention to provide a system in which by keeping a balance between the number of production per order and the number of suppliable products with respect to a certain delivery date, it is possible to cope with the shortage of the number of products which are supplied, and the customer to whom the delivery date can be changed is enabled to purchase a product under conditions corresponding to the changed delivery date.

According to the invention, the problems of the conventional techniques are solved and there is provided a network selling system in which in the case where the number of suppliable products runs short for the placement of orders or demand, the customers who can change the delivery date of a product or change the product to another product are advertised on condition that bonuses such as price discount, service addition, and the like are presented, and a sales quantity is adjusted to a suppliable range (that is, a range of the number of products which can be supplied to the customers), thereby enabling sales which is more advantageous to the selling side to be made and enabling the customers to voluntarily select purchasing conditions such as trade-off and the like of the delivery date and the price by the advertisement.

According to the invention, there is also provided a Web selling system which is constructed by a plurality of client apparatuses and a server apparatus via a network and used for selling products, wherein in the case where the number of suppliable products runs short for the placement of orders or demand, the customers who can change the delivery date of a product or change the product to another product are advertised on condition that bonuses such as price discount, service addition, and the like are presented, and a sales quantity is adjusted to the suppliable range.

According to the invention, there is also provided a Web selling system having a function for automatically extracting advertisement target customers from order-accepted items under ordering conditions such as payment method, selling price, and the like.

According to the invention, there is also provided a Web selling system having an automatic notifying function such as facsimile, E-mail distribution, display on a Web picture plane, or the like as an advertising method to the customers.

According to the invention, there is also provided a Web selling system which can select a price discount, a point addition, an appending of a free product, or the like as a bonus for a change in delivery date.

The invention has originality on the following constructions and effects against the conventional techniques.

(1) Although JP-A-2000-57214 relates to interactive communication in which (the customer:the selling side) is set to (1:1), the invention relates to an order accepting system for making interactive communication in which (the customer:the selling side) is set to (n:1) (that is, it advertises for a plurality of customers).

(2) According to JP-A-2000-57214, customer conditions are discriminated with respect to one point that a procurement/manufacturing lead time of parts is compared with the delivery date. According to the invention, the customer conditions are discriminated from a plurality of viewpoints such as “the number of products”, “payment conditions”, and the like as well as the comparison between the lead time and the delivery date, so that more advantageous order-accepted items to which priority should be given to the selling side can be extracted.

(3) According to JP-A-2000-57214, although the customer conditions are presented to the customers by setting differences in the product prices (that is, discounting) in dependence on whether the delivery date is early or late, the orders are eventually accepted in order from the customer who early applied for the product to the selling side.

(There is a fear that a chance of getting orders of the advantageous customer who applied for later is lost.)

On the other hand, according to the invention, even if “the customer who is more advantageous to the selling side (with respect to the selling price, payment conditions, the number of products, etc.)” applied for later at the competition delivery date, among a plurality of customers of the relevant product, the system advertises for the customers who can change the delivery date or change the products to alternatives on condition that services (discount and the like) are added.

Consequently, the selling side can assure more advantageous booked order items.

As mentioned above, according to the invention, there are following effects such that the problems of the conventional technique are solved, not only the customer can select the conditions such as delivery date and the like when and after he orders (ordered) the products but also an additional value such as addition of a bonus of a price discount or the like is presented to the customer, and the selling side can perform more advantageous sales activity.

Further, on the selling system of products by using the network, it is possible to enable the customer to select the ordering conditions in a real-time manner not only before he orders and when the order is accepted but also after he ordered.

Other objects, features and advantages of the invention will become apparent from the following description of the embodiments of the invention taken in conjunction with the accompanying drawings.

### BRIEF DESCRIPTION OF THE DRAWINGS

FIG. 1 is a whole processing flowchart for a discount sale by acceptance of postponement of a delivery date according to an embodiment of the invention;

FIG. 2 is a whole constructional diagram of the discount sale by acceptance of the postponement of the delivery date according to the embodiment of the invention;

FIG. 3 is a processing flowchart showing an advertisement target customer extracting procedure according to the embodiment of the invention;

FIG. 4 is a processing flowchart showing a discount sale procedure by the acceptance of postponement of the delivery date of a booked customer according to the embodiment of the invention;

FIG. 5 is a processing flowchart showing a discount sale procedure by the acceptance of postponement of the delivery date of a new customer according to the embodiment of the invention;

FIG. 6 is a whole constructional diagram of a Web selling system as a prerequisite of the invention;

FIG. 7 is a table construction of suppliable number information according to the embodiment of the invention;

FIG. 8 is a table construction of order-accepted item information according to the embodiment of the invention; and

FIG. 9 is a diagram showing a server apparatus in the embodiment of the invention.

### DESCRIPTION OF THE EMBODIMENTS

An embodiment of the invention will be described in detail hereinbelow with reference to the drawings.

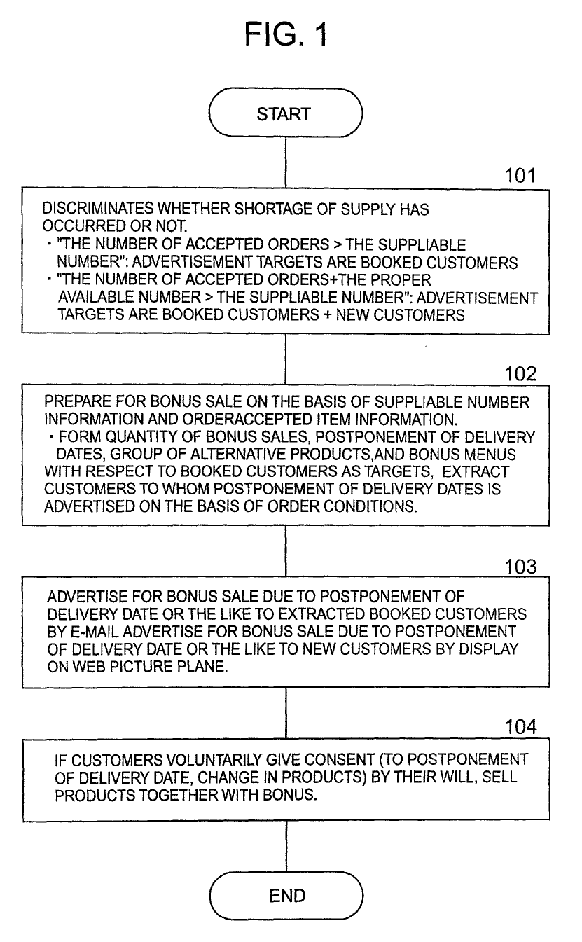

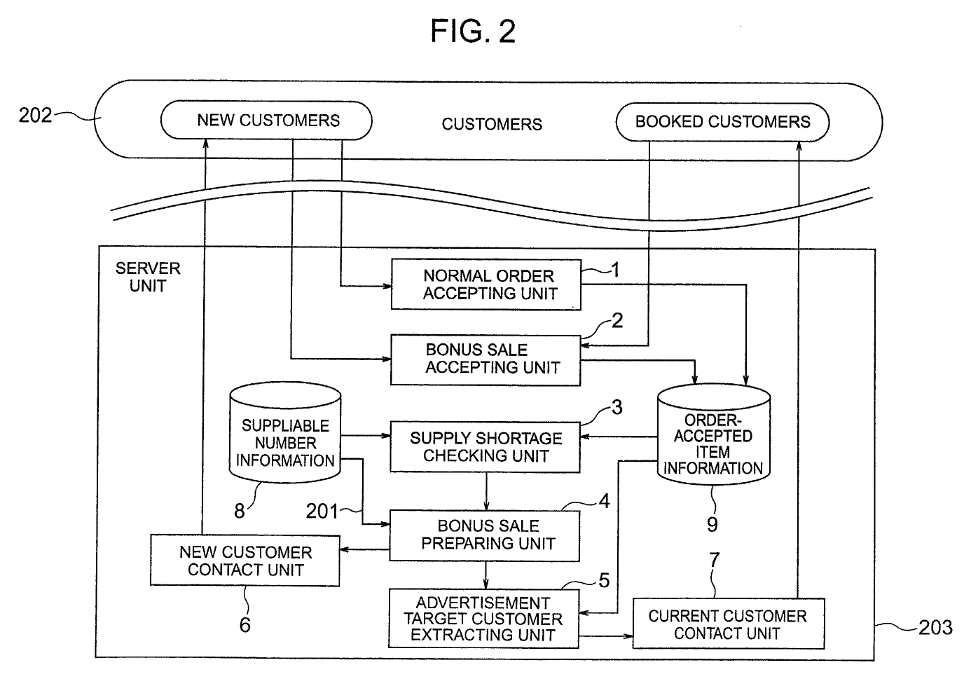

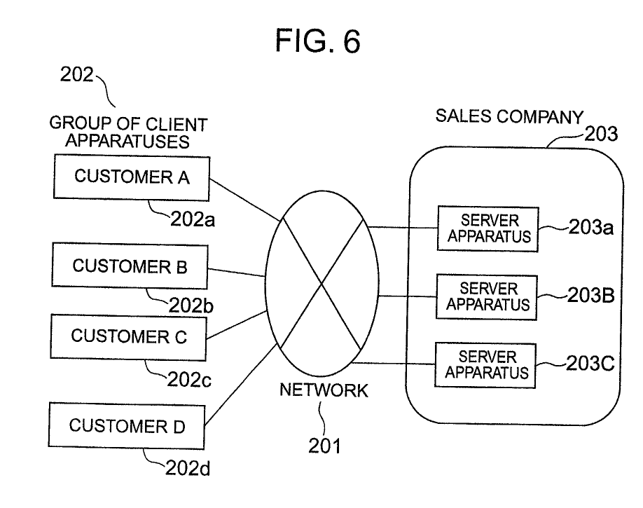

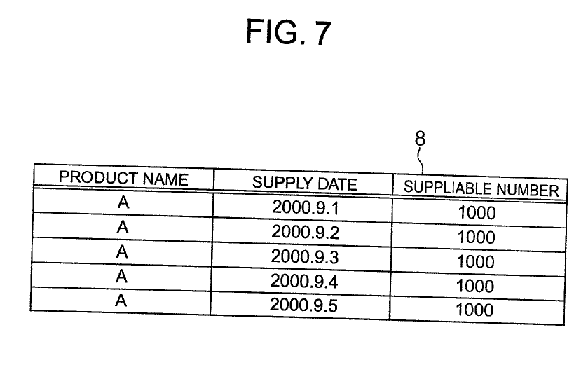

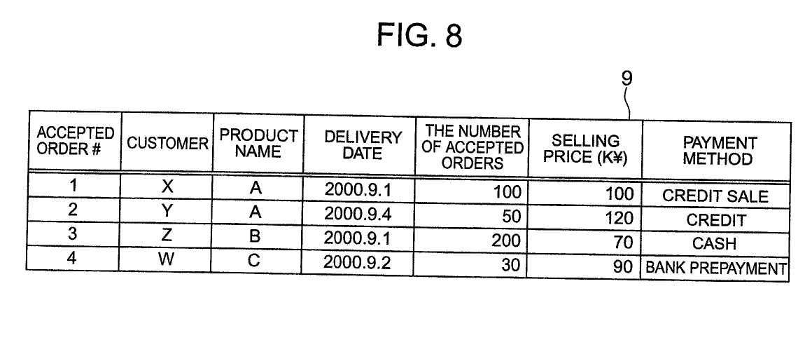

FIGS. 1 and 3 to 5 show processing flows of the embodiment. FIG. 2 shows a whole constructional diagram of a system of the embodiment. FIG. 6 shows a construction of a Web selling system. FIG. 7 shows a table construction of suppliable number information (that is, information indicative of an amount of products which can be supplied). FIG. 8 shows a table construction of order-accepted item information.

First, FIG. 6 shows a construction of the Web selling system as a prerequisite of the invention. In the embodiment, a sales company 203 including servers 203a to 203c constructing the selling system is connected to a plurality of clients 202a to 202d via an Internet 201. The number of servers is variable in dependence on processing performance of the server for the clients.

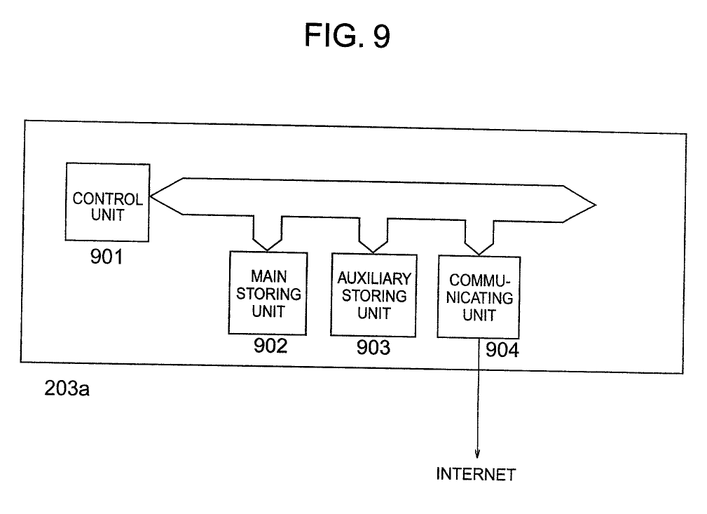

FIG. 9 shows an example of a construction regarding the embodiment in the server 203a. The server 203a has: a control unit 901 for controlling its own apparatus; a main storing unit 902 for storing data which is used for an extracting process of target customers of advertisement by the control unit 901; an auxiliary storing unit 903 for storing various information; and a communicating unit 904 for connecting to the Internet.

Details of the system will now be described with reference to FIG. 2.

The system comprises: a normal order accepting unit 1 for accepting a normal order from a new customer; a bonus sale accepting unit 2 regarding a product in which a shortage of supply has occurred; a supply shortage checking unit 3 for discriminating whether a delivery date is delayed because of a shortage of a suppliable quantity (that is, a quantity of products which can be supplied) as compared with the number of orders or not; a bonus sale preparing unit 4 for calculating a quantity of products which are sold with a bonus when advertising for the customers, a suppliable delivery date (that is, a delivery date on which the product can be actually delivered) in case of postponement of the delivery date, a group of alternative candidates in case of changing the products, and a bonus menu in the case where the customer gave consent to the change; an advertisement target customer extracting unit 5 for extracting a list of customers as advertisement targets; a new customer contact unit 6 for notifying the new customer of the bonus sale accompanied by the change in delivery date or the change in product; a current customer contact unit 7 for notifying the order-accepted customer of the bonus sale accompanied by the change in delivery date or the change in product; suppliable number information (that is,, information indicative of the number of products which can be supplied) 8; and order-accepted item information 9.

Those component elements are constructed by the server 203 shown in FIGS. 6 and 9. The control unit 901 realizes the supply shortage checking unit 3, bonus sale preparing unit 4, and advertisement target customer extracting unit 5. The storing units 902 and 903 store the order-accepted item information 9 and suppliable number information 8. In the embodiment, the communicating unit 904 realizes the normal order accepting unit 1, bonus sale accepting unit 2, new customer contact unit 6, and current customer contact unit 7.

FIGS. 7 and 8 show examples of the suppliable number information 8 and order-accepted item information 9. As shown in FIG. 7, in the suppliable number information 8, the suppliable numbers have been written every product and every supply date. As shown in FIG. 8, in the order-accepted item information 9, a product name, a delivery date, and the number of accepted orders have been written every order item.

A whole processing outline of the embodiment will now be described with reference to FIG. 1.

First, in step 101, the supply shortage checking unit 3 discriminates whether the shortage of the suppliable quantity has occurred as compared with the number of orders due to some factors or not. This discrimination is made at timing when there is a change in suppliable number information 8. By discriminating the shortage of supply at such timing, it is possible to cope with a change in supplying situation due to the change in suppliable number information 8 in a real-time manner. The shortage of supply can be also discriminated before a new order is accepted or after a new order is accepted. Further, such discrimination can be also made by a combination of those two timings.

An algorithm for such discrimination can be easily realized by comparing the number of accepted orders with the suppliable number at each delivery date. That is, in the suppliable number information 8 and order-accepted item information 9 shown in FIGS. 7 and 8, the algorithm can be realized by comparing the sum of the numbers of accepted orders with the suppliable number every product and on each delivery date.

In the embodiment, a state of the shortage of supply denotes a case of “(the number of accepted orders)>(the suppliable number)”. In this case, the booked customers are asked to see if the delivery date can be changed or the ordered product can be changed to an alternative whose specifications are slightly different.

If the shortage of supply actually occurs, in step 102, first, the bonus sale preparing unit 4 calculates a quantity of the products corresponding to the shortage of supply and a suppliable delivery date of the products of the number corresponding to the quantity. The quantity of the products corresponding to the shortage of supply can be calculated by comparing the suppliable number information 8 with the order-accepted item information 9 as mentioned above. The suppliable delivery date of the products regarding the number corresponding to the quantity of the shortage of supply can be also calculated by using a general delivery date answering algorithm on the basis of the suppliable number information 8 and the order-accepted item information 9. The quantity of the shortage of supply is, that is, a quantity of bonus sale.

A group of alternative products for the products in which the shortage of supply has occurred is also calculated. It can be calculated by a method whereby a list of alternative candidate products is preliminarily formed every product, and the products in which the shortage of supply does not occur at this point of time and, even if the quantity of the shortage of supply is added to the current number of products, there is no risk of occurrence of the shortage of supply are extracted among those lists. That is, since the group of alternative products also changes successively in dependence on a supply-demand situation of each time, it is necessary to calculate the group of alternative products at that time point.

In this instance, a bonus menu is also formed. It can be realized, for example, by the following method. First, if the customer accepts the postponement of the delivery date instead of the initial delivery date, since the prices of the parts as raw materials also drops due to the delayed delivery date, such a price-down can be reflected to the bonus. If a budget has previously been assured in order to prepare for such a situation, an expense for the bonus corresponding to the present shortage of supply can be calculated by adding such a budget. Further, by selecting a bonus according to the level corresponding to the present expense for the bonus in accordance with a kind of each bonus such as discount, addition of points, appending of a free product, or the like, a list of bonus menus corresponding to the present shortage of supply can be automatically formed.

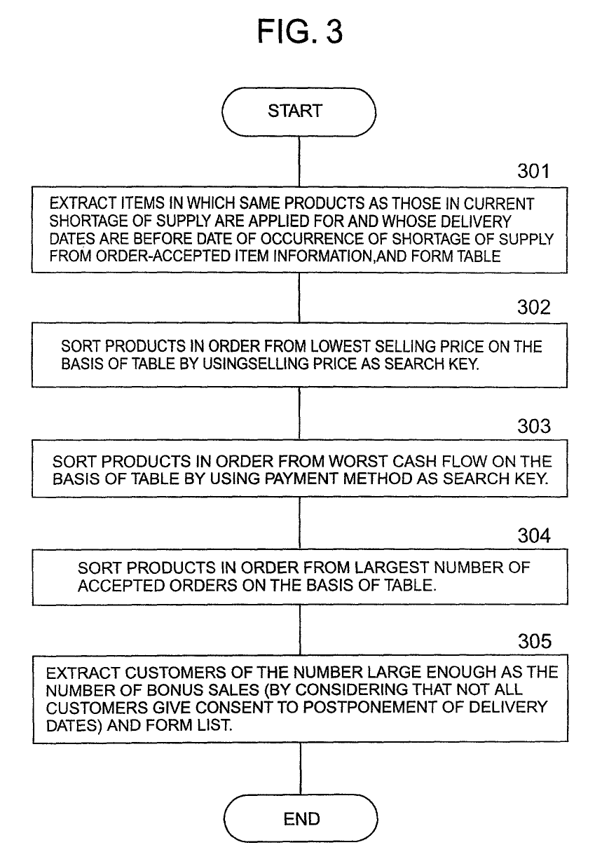

After completion of a preparation for the bonus sale as mentioned above, that is, a preparation for the quantity of bonus sales, the suppliable delivery date in case of the postponement of the delivery date, a group of alternatives in case of changing the products, and the list of bonus menus regarding the postponement of the delivery date and the kind change, with respect to the booked customers as targets, the customers to whom the postponement of the delivery date or the change in product is advertised are extracted by the advertisement target customer extracting unit 5 on the basis of the order conditions (step 102). Processes in this step will be described hereinlater with reference to FIG. 3.

To the extracted booked customers, the change in order with a bonus is advertised by using the current customer contact unit 7 (step 103). In the embodiment, it is assumed that the current customer contact unit 7 is realized by the communicating unit 904 as connecting means for connecting to the network. As specific means for realizing it, although E-mail distribution using the Internet or insertion to a customer-only homepage can be mentioned, the invention is not limited to them but various methods such as telephone call, direct mail, FAX automatic transmission, and the like can be used. Further, to the customers who voluntarily give consent in accordance with the advertisement for the customers, the accepted orders are changed to the bonus orders by using the bonus sale accepting unit 2 (step 104).

An embodiment of an internal processing procedure for the advertisement target customer extracting unit 5 of the invention will now be described with reference to FIG. 3.

First, order-accepted items before the date of occurrence of the shortage of products are extracted from the order-accepted item information 9 shown in FIG. 8 from the products in which the shortage of supply occurred, thereby forming a table in a format similar to that in FIG. 8. The items shown in this table correspond to the whole candidates of the customers who are asked to change the products or the delivery dates in response to the present shortage of supply (step 301). With respect to the items extracted in step 301, the data is sorted in order from the lowest selling price by using a “selling price” condition as a first key (step 302). Further, the data is sorted in order from the worst cash flow by using a “payment method” condition as a second key (step 303). Moreover, the data is sorted by using the number of accepted orders of each item as a third key (step 304). Finally, by considering the fact that the consents to the postponement of the delivery date cannot be always given from all of the customers, the customers of the number which sufficiently exceeds the quantity of bonus sales are extracted in order from the beginning of the sorting operation, thereby forming a list of the customers (step 305).

Although the data has been sorted in order of “the selling price”, “the payment conditions”, and “the number of accepted orders” in this example, the sorting order can be changed or it is also possible to solely sort the data with respect to each condition and extract the relevant customers. The data can be also sorted on the basis of attribute information of the customers themselves such as whether the customer is an important customer or not, whether the customer has purchased other products or not, a transaction amount so far, and the like. In this case, the information of the customers themselves is stored into a customer DB. By extracting the customers as targets to whom the change in order acceptance conditions is presented by using the foregoing items as mentioned above, the order-accepted items to which priority should be given by the selling side can be effectively extracted.

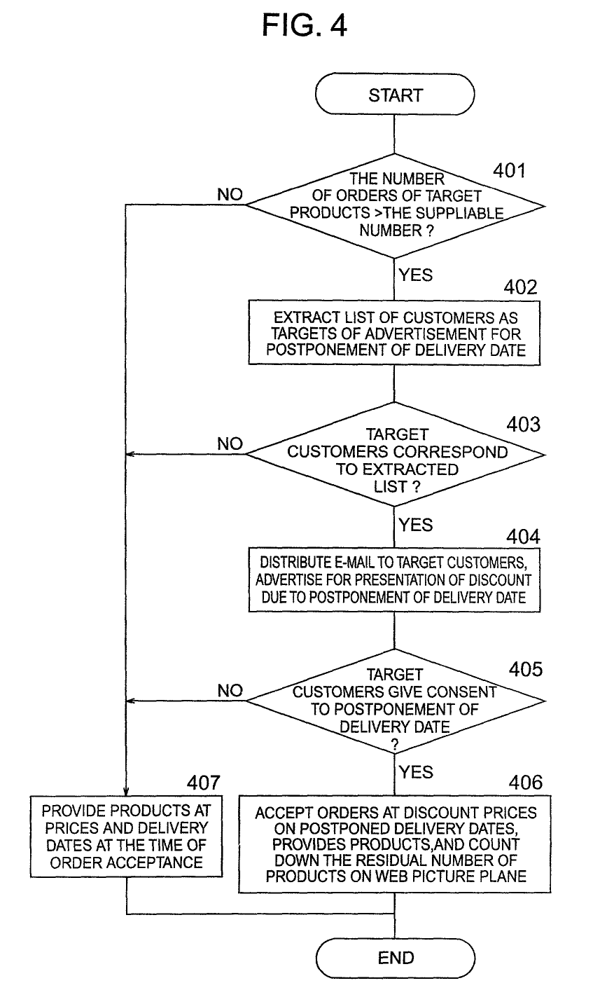

A whole flow of the bonus sale by the consent to the postponement of the delivery dates by the booked customers in the invention will now be described as an example with reference to FIG. 4.

First, while getting orders, whether the suppliable number is lacking for the number of orders or not is always discriminated by the supply shortage checking unit (step 401). If it is not lacking (NO in step 401), the products are provided as they are at the prices on the delivery dates at the time of the order acceptance (step 407). If it is lacking (YES in step 401), the list of target customers of advertisement for postponement of the delivery date is extracted (step 402). E-mail is distributed to the customers corresponding to the list (step 404). The products are provided as they are to the customers who do not correspond to the list at the prices on the delivery dates at the time of the order acceptance (steps 403, 407). If the customers who received the E-mail give consent to the postponement of the delivery date and place orders again, the products are provided at the discount prices on the postponed delivery dates, and the residual number of products advertised on the Web picture plane is counted down (steps 405, 406). The products are provided as they are to the customers who do not give consent at the prices on the delivery dates at the time of the order acceptance (step 407).

Although the postponement of the delivery date has been shown in this example, the products can be also similarly changed. Although the advertisement is made to the customers who were extracted first and the advertisement is finished in this example, if the sufficient number of applications is not obtained by such an advertisement, it is also possible to sequentially widen a target range of the customers who are subjected to the advertisement and repetitively advertise. Further, although the contents of the bonuses are also constant in this example, if the sufficient number of applications is not obtained by such an advertisement, it is also possible to sequentially raise the bonus level and repetitively advertise.

As mentioned above, according to the embodiment, if the shortage of supply occurred, the customers to whom the delivery dates can be delayed are extracted in a real-time manner and the change in delivery dates is proposed to the plurality of extracted customers, so that a chance of receiving the bonus is provided to the customers for whom the early delivery is unnecessary, thereby enabling the order-accepted number during a period of time when the shortage of supply occurs to be reduced to a value which is equal to or less than the suppliable number. Therefore, even if the customers for whom the early delivery is necessary appear after the order acceptance, by delaying the delivery dates of the order acceptance in which importance is not attached to the delivery dates, it is possible to cope with the order acceptance of high emergency.

Although the order-accepted item information 9 has been stored into the auxiliary storing unit 903 in the embodiment, it can be also stored as a database into another storing device different from the auxiliary storing unit 903. Further, although the server has been independently constructed by the plurality of servers 203a to 203c in the embodiment, the invention is not limited to such a construction. Naturally, each of the normal order accepting unit 1, bonus sale accepting unit 2, and supply shortage checking unit 3 can be also constructed by a different server.

The second embodiment will now be described. According to the second embodiment, although a construction of the system is almost similar to that of the first embodiment, it differs with respect to a point that the control unit 901 makes prediction of order acceptance and a point that the state of the shortage of supply is defined as “the number of accepted orders+the proper available number>the suppliable number”. The order acceptance prediction can be also independently executed by one server.

A term “the proper available number” denotes the predictive number of orders which will be got at that delivery date in future. It can be obtained from a past order-getting distribution and a demand prediction. This means that if the suppliable number as many as “the proper available number” is lacking, a situation such that desired delivery dates of the new customers cannot be satisfied can occur.

Therefore, if a situation of “the number of accepted orders+the proper available number>the suppliable number” is detected and the system recognizes the shortage of supply, the application for the bonus sale is advertised by using the new customer contact unit 6 to the customers whose orders are newly accepted (hereinafter, abbreviated to new customers) in addition to the booked customers.

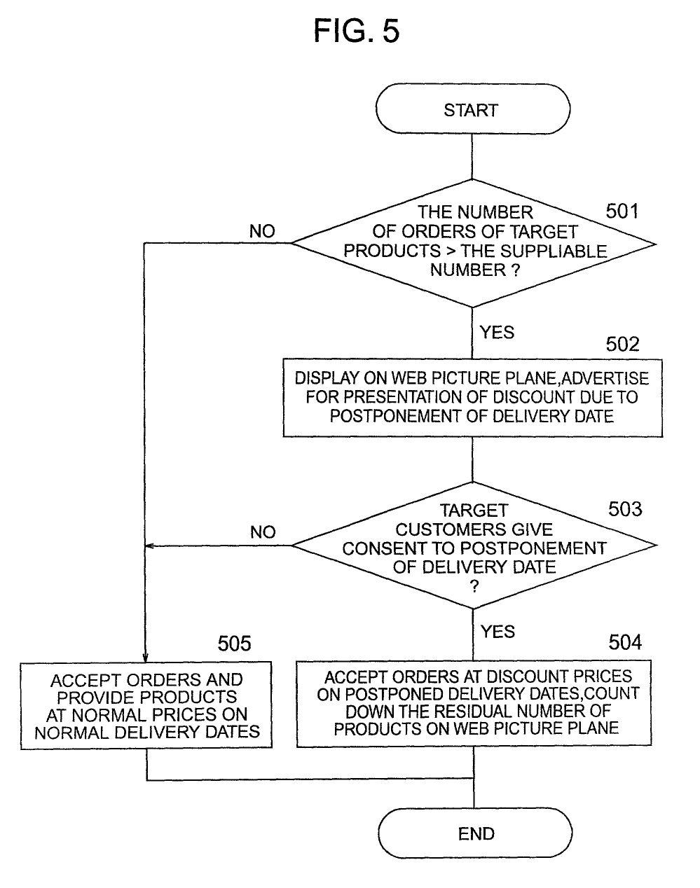

A whole flow for the bonus sale by the acceptance of the postponement of the delivery date of the new customers in the embodiment will now be described with reference to FIG. 5.

First, while the orders are continuously got, whether the suppliable number is lacking for the number of orders or not is discriminated by the supply shortage checking unit (step 501). If it is not lacking (NO in step 501), the products are provided as they are at the normal prices on the normal delivery dates (step 505).

If it is lacking (YES in step 501), the bonus sale due to the postponement of the delivery date, for example, the presentation of the discount is advertised (step 502). As specific means for realizing the new customer contact unit 6, there are an insertion to a homepage for general customers, an advertisement to newspapers and magazines, a presentation or advertisement in a portal site or a community site on the Internet, and an electronic commerce market, direct mail (also including direct mail by E-mail) to the potential customers, and the like. When the new customer inquires about the delivery date by using the delivery date answering function in the Web selling system, as a process on the server side, contents of the bonus sale can be also displayed as a message simultaneously with the answer of the delivery date.

For example, when the customer who watched the Web picture plane gives consent to the postponement of the delivery date and the order is accepted, the product is provided at a discount price and at an postponed delivery date, and the residual number of products advertised on the Web picture plane is counted down (steps 503, 504). The products are provided as they are to the customers who do not give consent at the normal prices and at the suppliable delivery dates at that point of time (step 505).

As mentioned above, by setting the shortage of supply into the case where the suppliable number is smaller than the sum of the number of order-accepted products and the number of products obtained by the order getting prediction, a message showing the delayed delivery dates can be proposed also to the customers who newly place orders. A possibility of the occurrence of the future shortage of supply can be further reduced.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A product selling system connected to a client apparatus via a network, comprising:
a storing unit for storing information of order-accepted products; and
a control unit for detecting a supply situation of said products,
wherein said control unit includes
means for deciding a plurality of customers serving as targets to whom a change in order acceptance conditions is presented on the basis of the information of said order-accepted products in a case where said product supply situation meets a predetermined condition, and
means for advertising for customers who accept the change in said order acceptance conditions among said plurality of customers via the network.

2. A system according to claim 1, wherein said predetermined condition relates to a case where the number of order-accepted products in a specific delivery period of time exceeds the number of products which can be supplied.

3. A system according to claim 1, wherein said control unit includes means for detecting the supply situation of said products in a case where a change in number of order-accepted products or number of products which can be supplied in a delivery period of time of the order-accepted products occurs.

4. A system according to claim 3, wherein said control unit includes means for calculating the predictive demand number of products in said delivery period of time,
and said predetermined condition relates to a case where the sum of the number of order-accepted products and the predictive number of products to be ordered exceeds the number of products which can be supplied.

5. A system according to claim 1, wherein the information of said order-accepted products includes at least information regarding delivery dates of the order-accepted products, the number of products which are delivered, selling prices, and a payment method.

6. A system according to claim 1, further comprising an output unit for providing advertisement information to said customers serving as said targets of the advertisement via said network.

7. A system according to claim 6, wherein
said network is the Internet, and
said output unit includes a Web picture plane on the Internet.

8. A product selling system connected to a client apparatus via a network, comprising:
a control unit for detecting a supply situation of said products; and
an output unit for, in the case where a supply situation of said products in a specific delivery period of time does not satisfy a predetermined condition, presenting order acceptance conditions of a delivery date later than said delivery period of time to the customers via said network,
wherein said output unit includes means for presenting said order acceptance conditions of said delayed delivery date until said supply situation meets said predetermined condition.

9. A system according to claim 8, further comprising a storing unit for storing information regarding the order-accepted products including at least the number of order-accepted products,
and wherein said control unit includes means for detecting the predictive number of products to be ordered in said delivery period of time, and
said predetermined condition denotes a case where the number of products which can be supplied in said delivery period of time is larger than the sum of said number of order-accepted products and said predictive number of products to be ordered.

10. A product selling method of a product selling system connected to a client apparatus via a network, comprising the steps of:
successively holding information of the products which were order-accepted via said network into a storing unit; and
in a case where the number of products which are supplied in a predetermined delivery period of time for the products which are sold does not satisfy a predetermined condition, presenting a change in order acceptance conditions to the customers of the order-accepted products via said network on the basis of the information of said order-accepted products.

11. A Web selling system comprising:
a server apparatus; and
a plurality of client apparatuses connected to said server apparatus via a network,
wherein said server apparatus includes means for, when the number of products which can be supplied is lacking for order applications or demand, advertising for a change in delivery dates of the products or a change to alternatives to the customers on condition that a bonus like a price discount, a service addition, or the like is provided, thereby adjusting a sale amount into a suppliable range.

12. A system according to claim 11, wherein said server apparatus includes means for automatically extracting the target customers of said advertisement in accordance with order-accepted items on the basis of order conditions such as payment method, selling price, and the like.

13. A system according to claim 11, wherein said server apparatus includes automatic notifying means such as facsimile, E-mail distribution, display on a Web picture plane, or the like as a method of the advertisement to the customers.

14. A system according to claim 11, wherein said server apparatus includes means for providing a price discount, a point addition, an appending of a free product, or the like as a bonus for the change in delivery date so that they can be selected.

15. A Web selling method comprising the steps of:
advertising for postponement of delivery dates of products to customers in a case where the number of products which can be supplied is lacking for the number of orders; and
selling the products by adding an additional value when the customers voluntarily apply for said advertisement.
